(19) United States
(12) Patent Application Publication
(10) Pub. No.: US 2020/0340523 A1
(43) Pub. Date: Oct. 29, 2020

(54) AXIAL NEEDLE BEARING AND METHOD FOR PRODUCING A SHEAVE OF AN AXIAL NEEDLE BEARING OF THIS KIND

(71) Applicant: Schaeffler Technologies AG & Co. KG, Herzogenaurach (DE)

(72) Inventors: Wolfgang Fugel, Nürnberg (DE); Tanja Weissbrodt, Höchstadt (DE)

(73) Assignee: Schaeffler Technologies AG & Co. KG, Herzogenaurach (DE)

(21) Appl. No.: 16/960,677

(22) PCT Filed: Dec. 17, 2018
(86) PCT No.: PCT/DE2018/101002

§ 371 Date: Jul. 8, 2020

(30) Foreign Application Priority Data
Jan. 10, 2018 (DE) 10 2018 100 392.7

(51) Int. Cl. F16C 19/30; F16C 33/34; F16C 33/46

(52) U.S. Cl. CPC F16C 19/305; F16C 33/467; F16C 33/34

(57) ABSTRACT

An axial needle bearing includes a sheave and a cage. The sheave includes a radially outer sheave section having a rolling body race, a connecting angled thrust rib, and a ring section which is connected to the thrust rib and axially offset with respect to the sheave section. The disc-like cage retains bearing needles in pockets rolling on the rolling body race. The cage is fixed in position axially by a plurality of retaining sections extending radially from the ring section over the thrust rib and engaging over the cage, beneath each of which retaining sections a recess is provided in the sheave. The recesses beneath the retaining sections have a U-contour as they are worked into the sheave and are designed to extend with the web of the U-contour into the sheave section and with the ends of the U-contour into the ring section.

### CROSS-REFERENCE TO RELATED APPLICATIONS

This application is the U.S. National Phase of PCT Appln. No. PCT/DE2018/101002 filed Dec. 7, 2018, which claims priority to DE 10 2018 100 392.7 filed Jan. 10, 2018, the entire disclosures of which are incorporated by reference herein.

### TECHNICAL FIELD

The disclosure relates to a thrust needle roller bearing which can be applied in to the system for mounting the planetary gears of a planetary gear set in an automatic motor vehicle transmission. The disclosure further relates to a method for producing a washer disk of a thrust needle roller bearing of this type.

### BACKGROUND

In planetary gear sets of modern automatic motor vehicle transmissions, as a result of existing legal emissions limits. the thrust washers which are conventionally arranged between the planetary gears and the planetary gear carriers are increasingly being replaced with thrust needle roller bearings, which produce less friction. Thrust needle roller bearings have approximately the same axial height as the thrust washers used previously and are known for example from WO 2014/121769 A1. The washer disk of this single-row thrust needle roller bearing has a radially inner ring portion, which is adjoined by a thrust rib which is at a 90° angle, followed by a radially outwardly extending disk portion which again is at a 90° angle. A cage having bearing needles received in pockets is positioned in the region of this disk portion, the bearing needles rolling on the disk portion having a corresponding rolling element raceway. The disk portion ends in a radially outer thrust rib which again is at a 90° angle and is provided with inwardly projecting detents which are used to fix the cage to the washer disk. During assembly, the cage is pressed against said detents so that, in the final assembled position, said cage is locked behind said detents and is thus axially fixed in position.

A disadvantage of a thrust needle roller bearing of this type is that with the increasing use of planetary gears having very small diameters, and the resulting use of correspondingly small thrust needle roller bearings, only correspondingly short rolling elements having small diameters can be used in the thrust needle roller bearings, and a thrust needle roller bearing equipped with rolling elements of this type thus has only a relatively low load capacity. In the case of the thrust needle roller bearing known from WO 2014/121769 A1, it is not possible to use longer rolling elements due to the cage being snapped onto the outer edge of the washer disk.

JP 2013-61023 A1 further discloses a system for mounting the planetary gears of a planetary gear set by means of a two-row thrust needle roller bearing which has a washer disk, which washer disk has a radially inner disk portion having a rolling element raceway, an adjoining angled thrust rib, a central radial ring portion which adjoins the thrust rib and is axially offset from the inner disk portion, another adjoining angled thrust rib and a radially outer disk portion having a second rolling element raceway. The inner and outer disk portions are not delimited by corresponding inner and outer thrust ribs respectively. The cage is fixed to the washer disk by means of retaining portions which radially protrude on the central ring portion. Said retaining portions are each bent out of the thrust rib defining the adjacent disk portion, that is to say that there is a recess underneath the retaining portions in the thrust rib. The thrust rib is thus cut locally, a U-shaped separating cut is made which makes it possible for the corresponding retaining portion to then be bent out of the thrust rib.

In the case of this thrust needle roller bearing, by omitting the inner and outer thrust ribs, and by fixing the cages to the central radial ring portion, it is indeed possible to use longer rolling elements, but it has proven to be disadvantageous that, to produce the lugs for fixing the cages, the lugs have to be cut into said rolling elements from the inside of the central ring portion and bent upwards. If the washer disks are produced in a follow-on tool on a deep drawing press, as is conventional, the production of the lugs is thus possible only by means of highly complex special tools, resulting in high costs.

### SUMMARY

The disclosure addresses the problem of designing a thrust needle roller bearing in which the lugs for axially fixing the cage to the washer disk can be produced in a simple and inexpensive manner. The disclosure also addresses the problem of designing a method for producing the washer disk of a thrust needle roller bearing which is inexpensive and effective in terms of the resulting tool costs and the required manufacturing steps.

In the case of a thrust needle roller bearing, this problem is solved in such a way that the washer disk consists of only one disk portion, one thrust rib and one ring portion in each case, and that the recesses underneath the retaining portions, when incorporated into the washer disk, have a U-shaped contour and are formed firstly in such a way that the web of the U-shaped contour thereof extends into the disk portion, and secondly in such a way that the ends of the U-shaped contour thereof extend into the ring portion. This means that the washer disk is formed with large, window-like openings or clearances, through which the bending lines of the thrust rib run. The recesses simultaneously allow an improved supply and discharge of lubricant into and out of the thrust needle roller bearing.

The web of the U-shaped contour of the recesses underneath the retaining portions may extend no further than the rolling element raceway. The rolling element raceway may necessarily be narrower than the disk portion, since the rolling elements are received in the closed pockets of a disk-shaped cage that may be used. This means that the recesses can extend into the disk portion by a considerable amount, ultimately corresponding to the width of the cage up to the start of the pockets. The disk portion can therefore be opened over a considerably large surface area, which is expedient for a good lubricant supply, related to the fact that the recess also extends beyond the thrust rib.

Since the cage is snapped onto the thrust rib by means of the retaining portions, the pitch circle is shifted outward, which allows the use of longer needles. The recesses are already stamped into the flat disk or plate and, after shaping the disk, for example by combined cutting and bending, or deep drawing, form the corresponding retaining portions. The recesses or window-like openings allow a correspondingly good supply and discharge of lubricant as described.

The U-shaped contour of the recesses makes it possible for the thrust rib, which is at an angle firstly to the ring portion and secondly to the disk portion, to be readily shaped or bent correspondingly, since in the region of the lugs formed by the U-shaped recesses, the corresponding deformation can take place without the position or geometry of the lugs being adversely affected by the shaping. The lugs are thus bordered or released on both sides by the recesses. This allows simple shaping while ensuring that the lugs having the end-face retaining portions extend radially and thus running in parallel from the ring portion despite the shaping.

In this case, it may be expedient for at least three retaining portions that are distributed equidistantly from one another around the periphery of the thrust rib to be provided, which portions are thus spaced apart from one another by 120°. Of course it is also conceivable to form more than three retaining portions or lugs of this type.

A method for producing a washer disk for a thrust needle roller bearing of the type is described. Said method is characterized by the following steps: punching out the outside diameter and a central through hole of the washer disk from a thin-walled steel material to form a disk component; punching out the recesses having the U-shaped contour from the disk component to form lugs having the end-face retaining portions; shaping the disk component by means of the following individual steps, which take place simultaneously or successively: molding a radial inner edge which defines the inside diameter of the washer disk, molding the axial ring portion adjoining the inner edge of the washer disk, molding the thrust rib which is at an angle to the ring portion along a bending line which runs transversely through the ends of the U-shaped contour of the recesses, molding the disk portion which is at an angle to the thrust rib along a bending line which runs longitudinally through the web of the U-shaped contour of the recesses, shaping the lugs having the end-face retaining portions, which lugs, as a result of the bending of the thrust rib, now extend outward radially beyond said thrust rib.

The recesses are therefore preferably punched out with a U-shaped contour, which allows simple molding of the thrust rib without any risk of shaping the lugs together with the retaining portion. The deep-drawing mandrel of the shaping die is received in the region of the lugs or retaining portions so that a protrusion of the lug or of the retaining portion to the guide diameter is formed on the thrust rib. This protrusion thus defines the retaining portion which acts as a means for retaining the cage and thus a means for securing the cage on the washer disk.

Preferably, at least three recesses which are positioned so as to be distributed equidistantly from one another around the periphery are punched out, but it is also conceivable to punch out additional recesses.

The shaping itself is preferably carried out by deep drawing or combined cutting and bending, but of course any possible shaping method can be used.

### BRIEF DESCRIPTION OF THE DRAWINGS

The thrust needle roller bearing will be explained in greater detail below by way of an exemplary embodiment, with reference to the accompanying drawings. The drawings are schematic views in which:

FIG. 1 is a plan view of a thrust needle roller bearing,

FIG. 2 is an enlarged three-dimensional partial view of the thrust needle roller bearing from FIG. 1,

FIG. 3 is a sectional view of the thrust needle roller bearing from FIG. 1 along the line

FIG. 4 is an enlarged partial view of the thrust needle roller bearing from FIG. 1 in the assembled position with associated planetary gear,

FIG. 5 is a plan view of an undeformed, punched annular disk,

FIG. 6 is a plan view of the washer disk from FIG. 1, which is produced from the annular disk according to FIG. 5 by shaping,

FIG. 7 is a three-dimensional view of the washer disk from FIG. 6.

### DETAILED DESCRIPTION

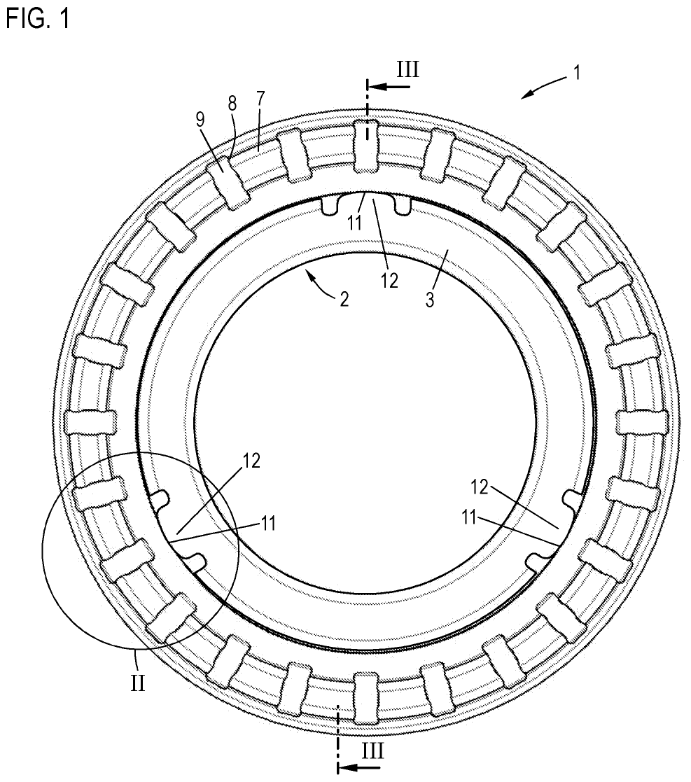

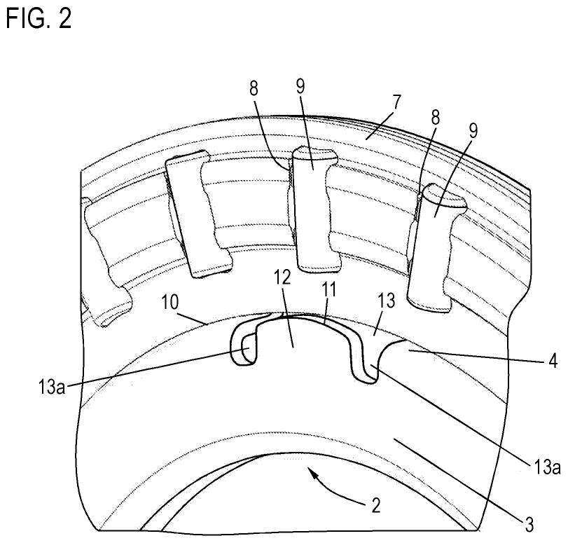

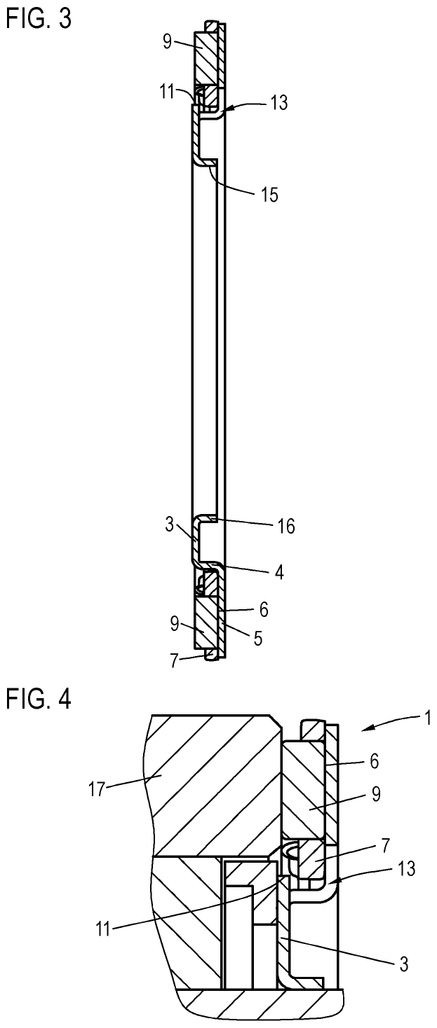

FIG. 1 shows a thrust needle roller bearing 1, comprising a washer disk 2 having a radially inner ring portion 3, on which, by means of an angled thrust rib 4, see in particular FIGS. 2 and 3, a disk portion 5 which is axially offset from the ring portion 3 and extends radially outward is provided; cf. FIG. 3. The disk portion 5 has a rolling element raceway 6, on which bearing needles 9 received in an annular cage 7 in corresponding pockets 8 roll. As can be seen in particular from FIG. 3, which shows a section along the line III-III from FIG. 1, the overall axial construction of the thrust needle roller bearing 1 is very narrow, the axial width is in the range of a few millimeters. In particular, the bearing needles 9 themselves can be very small, they have a length of a few millimeters in the case of a correspondingly small diameter. A thrust needle roller bearing 1 of this type is used for example to mount planetary gears of a planetary gear set which are designed with a very small diameter.

FIG. 2 is an enlarged, three-dimensional partial view of a cut-out from the region II in FIG. 1. The enlarged view shows firstly the washer disk 2 and secondly the cage 7 having the bearing needles 9. The cage 7 has an inner periphery 10 which is only slightly greater in diameter than the outer periphery of the thrust rib 4, as shown in particular by FIG. 2. This makes it possible, after fitting the cage 7 with the bearing needles 9, to place said cage on the washer disk 2 and thereby guide the axially increased ring portion 3 through the cage 7.

In order to then axially fix the cage 7 on the washer disk 2, a plurality of, in the example shown, three, retaining portions 11 extending radially from the ring portion 3 beyond the thrust rib 4 (see FIG. 1 and in particular FIG. 2) are provided. Said retaining portions 11 slightly overlap the cage 7 on the inner periphery 10 thereof so that said cage is axially secured.

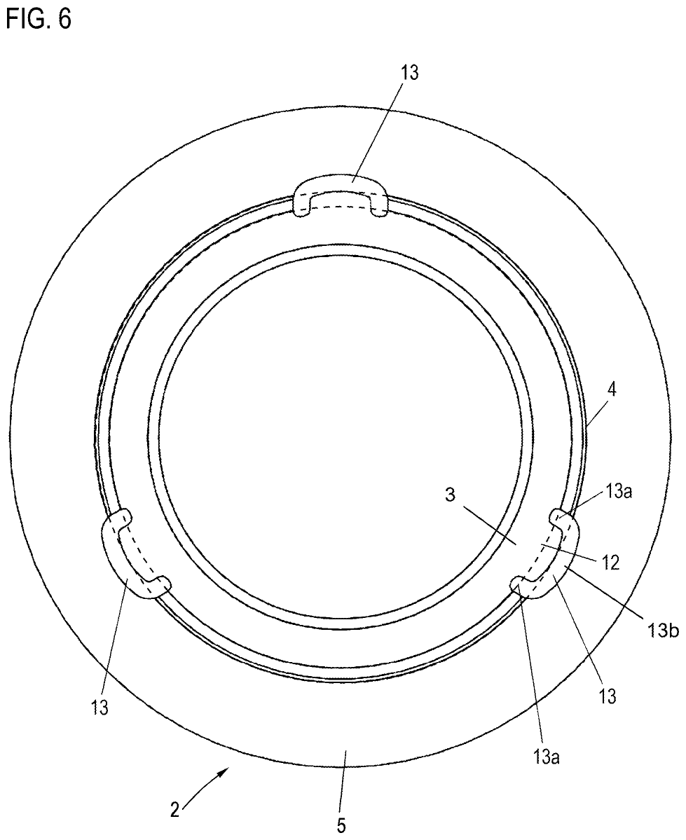

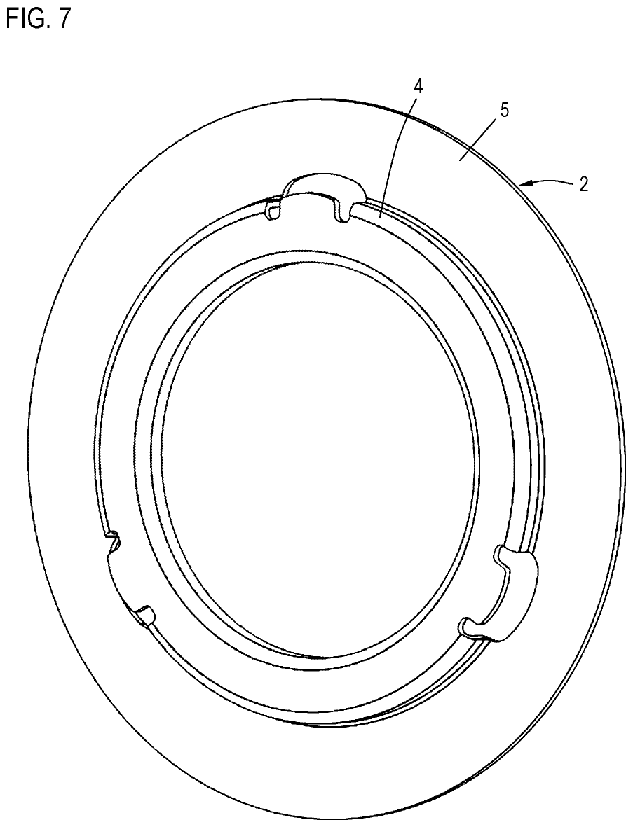

Underneath the retaining portions 11, which are formed by means of the end portions of corresponding lugs 12, which extend in a planar or radial manner to the ring portion 3, because they are formed therefrom, recesses 13 having a U-shaped contour are provided which extend into the disk portion 5 and into the ring portion 3 of the washer disk 2. This is clearly shown in FIGS. 6 and 7, where each washer disk 2 is shown in a plan view (FIG. 6) and a perspective view (FIG. 7) respectively. When viewed radially, the web 13b of the recesses 13 clearly extends into the region of the disk portion 5 to a certain extent, but not so far that the needles 9 would run over the recesses 13. This means that the recesses 13 do not extend as far as into the actual region of the rolling element raceway 6 on which the bearing needles 9 roll.

Moreover, the ends 13a of the recesses 13 extend, see for example FIG. 3 and in particular FIGS. 6 and 7, into the region of the ring portion 3 so that the recesses 13 altogether release the lugs 12 (see in particular FIG. 6). This makes it possible to correspondingly mold the thrust rib 4 without any problems, that is to say that the bending lines of the thrust rib 4, which are shown as dashed lines in FIG. 6, run transversely through the ends 13a and longitudinally through the web 13b of the recesses 13. This ensures that the lugs 12 are not deformed during this shaping, but rather still run radially, corresponding to the geometry of the ring portion 3.

The specific design of the recess 13, and in particular the fact that said recesses extend into the region of the disk portion 5 and the ring portion 3, additionally allows an ideal supply of lubricant into the region of the guidance of the bearing needles 9 and the cage 7 on the washer disk 2 and in particular on the rolling element raceway 6.

FIG. 4 shows an example of an assembly of the thrust needle roller bearing 1. The thrust needle roller bearing 1 is supported on a support (not shown in greater detail) to the right thereof. On the opposite side, by way of example a planet 17 is shown, which is supported and mounted on the bearing needles 9.

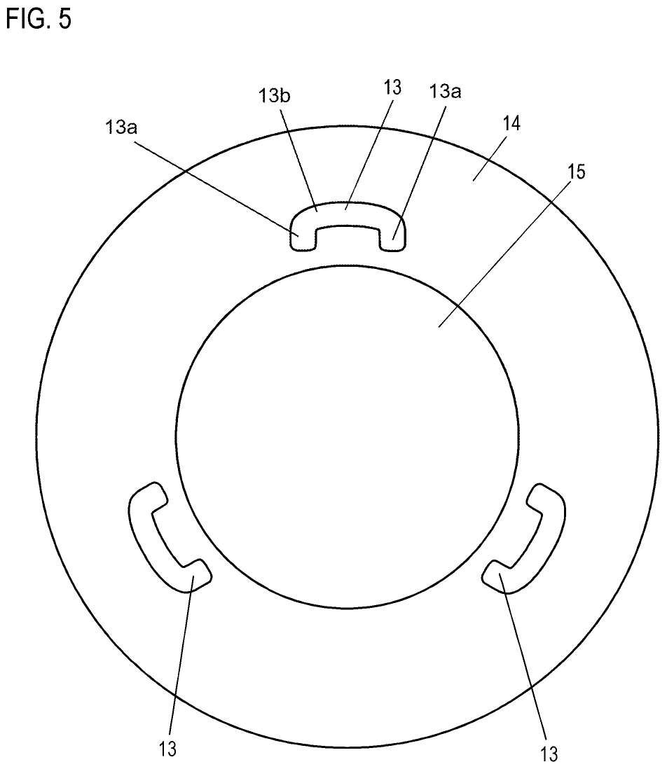

FIGS. 5, 6 and 7 show three drawings, by means of which the production process can be explained.

FIG. 5 shows a disk component 14. Said component was punched out of a correspondingly larger sheet metal component in a punching process. Firstly, the central through hole 15 is shown. Also shown are the three recesses 13, the basic shape of which has a U-shaped contour. This means that, in the basic component 14, also referred to as the round blank, firstly the central through hole 15, and secondly the at least three recesses 13, which can also be referred to as clearances, are punched out.

In a downstream bending process, the specific three-dimensional geometry of the washer disk 2 is then shaped. Firstly, a radial inner edge 16, see FIG. 3, is shaped, which defines the central through hole 15. The ring portion 13 adjoins said edge, which portion is adjoined, radially outwardly, by the thrust rib 4, which then transitions into the disk portion 5 that is bent out in turn. In this case, the lugs 12 and the end-face retaining portions 11 thereof are also shaped at the same time. For this purpose, the deep-drawing mandrel of the tool is received in the region of these retaining protrusions 11 so that the retaining portions 11 are formed as a protrusion of each lug 12 to the guide diameter. The height of these retaining portions 11, that is to say the length with which said portions radially protrude beyond the thrust rib 4, is variable and ultimately depends on the size or geometry of each punched-out recess 13.

As described, the retaining portions 11 are used to snap the cage 7 onto the washer disk 2. This allows a minimal radial height. As a result of the punched recesses 13, in the downstream bending process, it is possible to produce a very precise geometry of the retaining means 11 and the position thereof relative to the thrust rib 4, and thus ultimately relative to the cage 7 as well. In the tool, no radial movements are required to produce the retaining portions 11, which allows fast production of the washer disk 2 and has an advantageous effect on the production costs. As a result of the omission of the outer edge on the radially outer end of the disk portion 5, furthermore a smaller round blank, that is to say a smaller disk component 14 is required, which has a positive effect on the outside diameter of the thrust needle roller bearing 1 but also on the maximum usable length of the bearing needles 9, since said needles can be designed to be slightly longer and thus also increase the load capacity of the bearing.

### LIST OF REFERENCE SIGNS

1 thrust needle roller bearing
2 washer disk
3 ring portion
4 thrust rib
5 disk portion
6 rolling element raceway
7 cage
8 pockets
9 bearing needles
10 inner periphery
11 retaining portions
12 lug
13 recess
13a ends of 13
13b web of 13
14 disk component
15 through hole
16 inner edge
17 planet

1. A thrust needle roller bearing, comprising a washer disk which has at least one radially outer disk portion having a rolling element raceway, an adjoining angled thrust rib, and a radial ring portion which adjoins the thrust rib and is axially offset with respect to the disk portion, and further comprising at least one disk-shaped cage having bearing needles which are received in pockets and roll on the rolling element raceway, the cage being axially fixed by a plurality of retaining portions which radially extend from the ring portion beyond the thrust rib and overlap the cage, a recess being formed in the washer disk under each of said portions, wherein the washer disk consists of only one disk portion, one thrust rib and one ring portion in each case, and in that the recesses underneath the retaining portions, when incorporated into the washer disk, have a U-shaped contour and are formed firstly in such a way that the web of the U-shaped contour thereof extends into the disk portion, and secondly in such a way that the ends of the U-shaped contour thereof extend into the ring portion.

2. The thrust needle roller bearing as claimed in claim 1, wherein the web of the U-shaped contour of the recesses underneath the retaining portions extends no further than the rolling element raceway.

3. The thrust needle roller bearing as claimed in claim 2, wherein at least three retaining portions that are distributed so as to be equidistant from one another around the periphery of the thrust rib are provided.

4. A method for producing a thrust needle roller bearing as claimed in claim 1, the method comprising:
punching out the outside diameter and a central through hole of the washer disk from a thin-walled steel material to form a disk component;
punching out the recesses having the U-shaped contour from the disk component to form lugs having the end-face retaining portions; and
shaping the disk component by means of the following steps, which take place simultaneously or successively:
molding a radial inner edge which defines the inside diameter of the washer disk,
molding the axial ring portion adjoining the inner edge of the washer disk,
molding the thrust rib which is at an angle to the ring portion along a bending line which rims transversely through the ends of the U-shaped contour of the recesses,
molding the disk portion which is at an angle to the thrust rib along a bending line which runs longitudinally through the web of the U-shaped contour of the recesses, and
shaping the lugs having the end-face retaining portions, which lugs, as a result of the bending of the thrust rib, now extend outward radially beyond said thrust rib.

5. The method as claimed in claim 4, wherein at least three retaining portions that are positioned so as to be distributed equidistantly from one another around the periphery of the thrust rib are punched out.

6. The method as claimed in claim 4, wherein the shaping of the disk component takes place by means of deep drawing.

7. The method as claimed in claim 4, further comprising attaching a cage to the washer disk such that the cage is retained between the lugs and the disk portion.

8. The method as claimed in claim 7 further comprising inserting a plurality of axial needle rollers into the cage.

9. A thrust needle roller bearing, comprising:
a washer disk having a radially outer disk portion with a rolling element raceway, an adjoining angled thrust rib, and a radial ring portion which adjoins the thrust rib and is axially offset with respect to the disk portion, the washer disk defining a plurality of U-shaped cut-outs such that webs of the U-shaped cut-outs extends into the disk portion, legs of the U-shaped cut-outs extend into the ring portion, and lugs between the legs of the U-shaped cut-outs extend radially outward beyond the angled thrust rib; and
a cage having bearing needles which are received in pockets and roll on the rolling element raceway, the cage being axially fixed by the lugs.

10. The thrust needle roller bearing as claimed in claim 9, wherein the web of the U-shaped cut-outs do not extend radially into the rolling element raceway.

11. The thrust needle roller bearing as claimed in claim 10, the plurality of U-shaped cut-outs comprise at least three U-shaped cut-outs.

12. The thrust needle roller bearing as claimed in claim 11 wherein the plurality of U-shaped cut-outs are equally spaced circumferentially around the washer disk.
